(19) United States
(12) Patent Application Publication
(10) Pub. No.: US 2003/0160694 A1
(43) Pub. Date: Aug. 28, 2003

(54) Apparatus for providing information to a user

(76) Inventor: Bryan Neil DeMatteo, New York, NY (US)

Correspondence Address: Kenyon & Kenyon, Attn: Bryan Neil DeMatteo, 10th Floor, 1 Broadway, New York, NY, 10004, US

(21) Appl. No.: 10/082,023

(22) Filed: Feb. 22, 2002

(51) Int. Cl. G08B 1/08

(52) U.S. Cl. 340/539.13; 340/995.24; 340/573.1

(57) ABSTRACT

An apparatus for providing information to a user at a resort, including a housing configured for being held and/or worn by the user; a power source for providing power; receiver circuitry situated in the housing for receiving resort-specific information; a memory unit situated in the housing and configured to store the resort-specific information; location determination circuitry including GPS circuitry configured to receive signals from GPS satellites for determining a geographical position of the apparatus; a processing arrangement including a communication unit configured to communicate the resort-specific information to the user; and a transmitting arrangement configured to wirelessly transmit at least the geographical position of the apparatus.

### FIELD OF THE INVENTION

The present invention relates to an information apparatus for providing resort-specific information to a user of the apparatus.

### BACKGROUND INFORMATION

Today, recreational activities provide enjoyment to a great many persons. As a business, it is believed that recreational resorts attract many patrons from areas far and near. In many instances, these resorts span much terrain, sometimes encompassing many square miles. For example, a ski resort may include numerous mountain peeks, ski lifts, and ski trails.

To help navigate the resort terrain, patrons may be provided maps. These maps, which may be, for example, foldable paper maps, help patrons find their way within the resort.

In addition to or in lieu of the paper maps, permanent hard maps may be provided throughout the resort at a plurality of suitably selected locations. For example, ski resorts often erect large billboard-type maps of their resorts at the tops of at least some of its ski lifts. These maps may include an arrow or other marker indicating the location of a particular skier within the resort. Also, these maps may include additional resort-specific information, such as, for example, which ski trails are closed, which ski lifts are operational, and/or snow conditions on certain ski trails.

Using either of the above maps, a patron may plan a course of travel throughout the resort, for example, a skier may plot a course of trails to ski. In doing so, the skier may avoid trails that may be closed and ski lifts that may not be operational. The skier may also plan the course in accordance with the skier's skill level, effectively avoiding trails that may be difficult to ski or may be otherwise treacherous.

It is believed that the paper foldable maps may be disadvantageous for a variety of reasons. For example, a skier may have to periodically remove the paper map from a pocket or other container to determine his/her location. Bulky gloves or mittens worn by the skier may make handling the map difficult, especially if the map needs to be folded after being read. Furthermore, snow or liquid condensate may damage the map, making it more difficult to handle and read. In addition, the paper maps may be difficult to read in low light conditions such as, for example, when night skiing.

Although the permanent billboard maps may avoid these problems, they are generally placed only in certain locations and thus may not be accessible at all times and at all locations within the resort.

It is believed that Global Positioning Satellite (GPS) systems are available that may avoid at least some of the disadvantages described above. GPS systems or GPS locators enable a user to determine his/her geographical location from signals received from earth orbiting satellites. The signals are processed and the geographical location is displayed to the user, for example, by visually indicating the user's geographical location on an area map via a visual display. For example, a GPS locator sold by Magellan may be programmed with an area map of a particular location, such as, for example, a ski resort. Using the GPS locator device loaded with a desired map, a user could determine his/her location at any time and in any place within the resort.

However, conventional GPS locator devices are believed to be unable to communicate resort-specific information in addition to the geographical position of the user. Without knowing certain resort-specific information, the user may be unaware of important resort conditions that may be subject to change periodically. For example, a skier may desire to know, for example, which trails are open, which ski lifts are operational, the congestion at a particular ski lift, e.g., a characterization of the number of people on line waiting to use the ski lift, and/or snow conditions on at least one ski trail (e.g., icy, packed powder, powder, etc). With this information, the skier may be better equipped to plan a course of travel throughout the resort.

### SUMMARY OF THE INVENTION

An object of the present invention is to provide an apparatus capable of overcoming the disadvantages described above by providing critical resort-specific information to a user, for example, a user located within a resort, including a housing configured for being at least one of held and worn by the user; a power source for providing power to the apparatus; receiver circuitry situated in the housing, the receiver circuitry including at least one of a first circuit arrangement configured to receive resort-specific information non-wirelessly and a second circuit arrangement configured to receive the resort-specific information wirelessly, the first circuit arrangement being further configured to receive the resort-specific information from an information source located within the resort, the second circuit arrangement being further configured to receive the resort-specific information automatically and periodically; a memory unit situated in the housing and configured to store the resort-specific information; and a processing arrangement, the processing arrangement including a communication unit configured to communicate at least a portion of the resort-specific information to the user.

Another object of an exemplary embodiment according to the present invention is to provide an apparatus as described above, in which the communication unit of the processing arrangement includes at least one of a visual interface arrangement and an audible interface arrangement.

Yet another object of an exemplary embodiment according to the present invention is to provide an apparatus as described above, in which the visual interface arrangement is configured to visually communicate at least the portion of the resort-specific information to the user and the audible interface arrangement is configured to audibly communicate at least the portion of the resort-specific information to the user.

Still another object of an exemplary embodiment according to the present invention is to provide an apparatus as described above, in which the visual interface arrangement is further configured to visually display at least a map of the resort.

Yet another object of an exemplary embodiment according to the present invention is to provide apparatus for providing information to a user at a ski resort, including a housing configured for being at least one of held and worn by the user; a power source for providing power to the apparatus; receiver circuitry situated in the housing, the receiver circuitry including at least one of a first circuit arrangement configured to receive resort-specific information non-wirelessly and a second circuit arrangement configured to receive the resort-specific information wirelessly, the first circuit arrangement being further configured to receive the resort-specific information from an information source located within the resort, the second circuit arrangement being further configured to receive the resort-specific information automatically and periodically, the resort-specific information including at least one of information relating to at least one of a plurality of ski trails, information relating to at least one of a plurality of ski lifts, information relating to a snow condition of at least one of the plurality of ski trails, and information relating to a skier congestion of at least one of the plurality of ski lifts; a memory unit situated in the housing and configured to store the resort-specific information; and a processing arrangement, the processing arrangement including a communication unit configured to communicate at least a portion of the resort-specific information to the user.

Yet another object of an exemplary embodiment according to the present invention is to provide an apparatus for providing information to a user at a resort, including a housing configured for being at least one of held and worn by the user; a power source for providing power to the apparatus; receiver circuitry situated in the housing, the receiver circuitry including at least one of a first circuit arrangement configured to receive resort-specific information non-wirelessly and a second circuit arrangement configured to receive the resort-specific information wirelessly, the first circuit arrangement being further configured to receive the resort-specific information from an information source located within the resort, the second circuit arrangement being further configured to receive the resort-specific information automatically and periodically; a memory unit situated in the housing and configured to store the resort-specific information; location determination circuitry including GPS circuitry configured to receive signals from GPS satellites, wherein the GPS circuitry determines a geographical position of the apparatus as a function of the signals; and a processing arrangement, the processing arrangement including a communication unit configured to communicate at least a portion of the resort-specific information to the user.

Still another object of an exemplary embodiment according to the present invention is to provide an apparatus as described above, in which the communication unit of the processing arrangement includes a visual interface arrangement configured to visually display to the user at least one of a map of the resort and the geographical position of the apparatus.

Yet another object of an exemplary embodiment according to the present invention is to provide an apparatus as described above, in which the visual interface arrangement is further configured to visually display at least the portion of the resort-specific information.

Still another object of an exemplary embodiment according to the present invention is to provide an apparatus as described above, in which the portion of the resort-specific information includes at least one of information relating to at least one of a plurality of ski trails, information relating to at least one of a plurality of ski lifts, information relating to a snow condition of at least one of the plurality of ski trails, and information relating to a skier congestion of at least one of the plurality of ski lifts.

Yet another object of an exemplary embodiment according to the present invention is to provide an apparatus as described above, further including an alarm arrangement configured to alarm the user if the geographical position of the apparatus coincides with a geographical position of at least one location within the resort.

Still another object of an exemplary embodiment according to the present invention is to provide an apparatus as described above, further including a user input arrangement configured to receive user inputted information from the user, the user inputted information including at least a skill level of the user, wherein the alarm arrangement alarms the user if the geographical position of the apparatus coincides with a geographical position of at least a portion of one of a plurality of ski trails having an assigned skill level that exceeds the skill level of the user.

Yet another object of an exemplary embodiment according to the present invention is to provide an apparatus as described above, further including a user input arrangement configured to receive user inputted information from the user, the user inputted information including at least one destination point located within the resort, wherein the processing arrangement is further configured to communicate a path of travel to the user, a beginning of the path of travel coinciding with the geographic position of the apparatus and an end of the path of travel coinciding with the at least one destination point.

Still another object of an exemplary embodiment according to the present invention is to provide an apparatus as described above, in which the communication unit of the processing arrangement communicates the path of travel to the user at least one of audibly and visually.

Yet another object of an exemplary embodiment according to the present invention is to provide an apparatus as described above, in which the user inputted information includes a skill level of the user, the path of travel being determined in accordance with the skill level of the user.

Still another object of an exemplary embodiment according to the present invention is to provide an apparatus as described above, in which the path of travel is determined in accordance with the resort-specific information.

Yet another object of an exemplary embodiment according to the present invention is to provide an apparatus as described above, in which the path of travel is determined in accordance with at least one of information relating to at least one of a plurality of ski trails, information relating to at least one of a plurality of ski lifts, information relating to a snow condition of at least one of the plurality of ski trails, and information relating to a skier congestion of at least one of the plurality of ski lifts.

Still another object of an exemplary embodiment according to the present invention is to provide an apparatus as described above, in which the path of travel traverses at least one of a portion of at least one of the plurality of ski trails and at least one of the plurality of ski lifts.

Yet another object of an exemplary embodiment according to the present invention is to provide an apparatus as described above, further including an alarm arrangement, the user inputted information including a skill level of the user, the alarm arrangement being configured to alarm the user if the geographical position of the apparatus coincides with a geographical position of at least a portion of one of the plurality of ski trails and a skill level assigned to the one of the plurality of ski trails exceeds the skill level of the user.

Yet another object of an exemplary embodiment according to the present invention is to provide an apparatus for providing information to a user at a resort, comprising a housing configured for being at least one of held and worn by the user; a power source for providing power to the apparatus;

receiver circuitry situated in the housing, the receiver circuitry including at least one of a first circuit arrangement configured to receive resort-specific information non-wirelessly and a second circuit arrangement configured to receive the resort-specific information wirelessly, the first circuit arrangement being further configured to receive the resort-specific information from an information source located within the resort, the second circuit arrangement being further configured to receive the resort-specific information automatically and periodically; a memory unit situated in the housing and configured to store the resort-specific information; location determination circuitry including GPS circuitry configured to receive signals from GPS satellites, wherein the GPS circuitry determines a geographical position of the apparatus as a function of the signals; a processing arrangement, the processing arrangement including a communication unit configured to communicate at least a portion of the resort-specific information to the user; and a transmitting arrangement configured to wirelessly transmit at least the geographical position of the apparatus.

Still another object of an exemplary embodiment according to the present invention is to provide an apparatus as described above, further including a position receiving arrangement configured to wirelessly receive at least one transmitted geographical position, the communication unit of the processing arrangement communicating the at least one transmitted geographical position to the user.

Yet another object of an exemplary embodiment according to the present invention is to provide an apparatus as described above, in which the communication unit of the processing arrangement communicates the at least one transmitted geographical position to the user only if a transmitted group tag assigned to the at least one transmitted geographical position matches a group tag assigned to the apparatus.

Still another object of an exemplary embodiment according to the present invention is to provide an apparatus as described above, further including a user input arrangement configured to receive user inputted information from the user, the user inputted information including at least group identifier information, wherein the group tag is assigned to the apparatus in accordance with the group identifier information.

Yet another object of an exemplary embodiment according to the present invention is to provide an apparatus as described above, in which the communication unit of the processing arrangement communicates the at least one transmitted geographical position to the user one of visually and audibly.

It should be noted that various exemplary apparatuses of the present invention are not limited to use at a ski resort. The various exemplary apparatuses may be used at any location, in which a user may desire to know certain resort-specific information concerning the location, i.e., information specific to and concerning the location, which may be subject to change while the user is present at the location. For example, the various exemplary apparatuses of the present invention may be used at national parks, biking resorts, nature hike resorts, amusement parks, college campuses, large corporate headquarters, etc.

Examples of resort-specific information include, but are not limited to, which of a plurality of trails at a resort may be open, areas of a resort which may be temporarily off limits to visitors, user congestion of a trail within the resort, locations of temporary terrain closures within the resort, locations of certain classes being given at a college campus, locations of certain meetings inside a corporate headquarters, and current terrain conditions at a certain location within the resort.

### BRIEF DESCRIPTION OF THE DRAWINGS

FIG. 1 shows a first exemplary apparatus according to the present invention.

FIG. 2 shows a communications unit of an exemplary apparatus according to the present invention.

FIG. 3 shows a second exemplary apparatus according to the present invention.

FIG. 4 shows a third exemplary apparatus according to the present invention.

FIG. 5 shows a fourth exemplary apparatus according to the present invention.

FIG. 6 shows a fourth exemplary apparatus according to the present invention communicating geographical position data with another exemplary apparatus according to the present invention.

### DETAILED DESCRIPTION

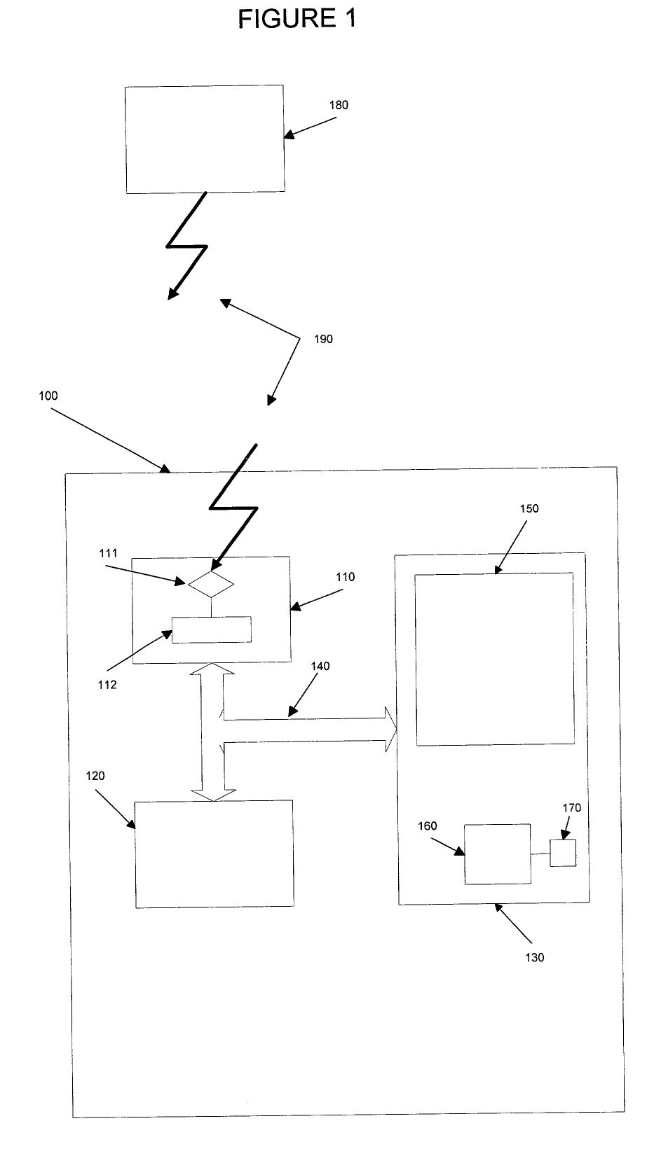

FIG. 1 shows an exemplary apparatus according to the present invention for providing information to a user, for example, to a user at a ski resort. The exemplary embodiment shown in FIG. 1 includes a housing 100, a power source for providing power to the apparatus, e.g., a battery (not shown), receiver circuitry 110 (having antenna 111 and radio processing circuitry 112), processing arrangement 130 (having microprocessor 160, processor memory 170, communications unit 150 (having visual interface arrangement 210), memory unit 120, alarm arrangement 420, data bus 140, location determination circuitry 310 (having GPS locator circuitry 320), user input arrangement 410, transmitting arrangement 510, and position receiving arrangement 520.

The housing 100 may be suitably sized and shaped in any configuration capable of being carried by a user, for example, the housing 100 may be shaped to fit in a hand or worn on a belt. In the exemplary embodiment shown in FIG. 1, the housing 100 is shaped to fit in the hand of a user, for example, a skier at a ski resort. However, it should be noted that the present invention is intended to extend to any size or shaped housing 100 capable of being worn or held by the user. For example, the housing 100 may be strapped to a body part (e.g., by velcro), held in a hand, placed in a pocket or container, or attached to accompanying gear.

Furthermore, the housing 100 may be constructed from a rugged material capable of withstanding moderate impact shock, such as that which may occur, for example, when a skier falls down while skiing. Suitable materials include, but are not limited to, plastic, aluminum, alloys of metals, or a combination of plastic aluminum and/or alloys of metals.

Moreover, the housing 100 may be constructed so that components situated inside the housing are protected from environmental elements. For example, in the skiing application, the housing 100 may be made water-resistant or waterproof to protect internal components from snow and/or liquid condensate.

The resort-specific information is received by the receiver circuitry 110 from a transmission source 180. The transmission source 180 may comprise a location within the resort configured to transmit the resort-specific information, for example, wirelessly over a radio transmission link or channel. In this manner, only a single transmission source 180 should be required to broadcast the resort-specific information, although a plurality of transmission sources may be employed. However, if the transmission source 180 proves inadequate to suitably transmit the resort-specific information to all desirable locations within the resort, conventional repeaters may be employed, which receive the incoming transmission from the transmission source 180 and then retransmit the transmission at a higher power.

It should be noted that the transmission source 180 need not be located within the resort. For example, the resort-specific information may be wirelessly transmitted by a centralized location off-site (e.g., outside the boundaries of the resort), such as, for example, wireless transmission by satellite or transmission by a transponder located outside the resort. In this manner, the resort could provide the resort-specific information to the transmission source 180, such as, for example, by telephone call, data transmission over the Internet, conventional wireless data transmission, and/or land-line data transmission (e.g., transmission over a cable, telephone wire, or the like). After receiving the resort-specific information, the transmission source 180 offsite may then transmit the information, which is then subsequently received by at least one exemplary apparatus according to the present invention, such as, for example, wirelessly by radio link.

Alternatively, the resort-specific information may be transmitted by the transmission source 180 using conventional non-wireless means known in the related art, such as, for example, over a cable or via a cradle connected to an information source, such as, for example, a personal computer or one of a plurality of data terminals located at a ski resort.

The transmission source 180 may receive information on the status of resort-specific information throughout the resort. For example, an employee working at one of a plurality of ski lifts may radio (e.g., “walkie-talkie”) or otherwise communicate the present congestion of the ski lift to the transmission source 180. Or, alternatively, the transmission source 180 may receive the information via a data transmission from one of various locations throughout the resort, for example, wirelessly or via a cable. In this regard, for example, the ski lift operator in the above example may input data into a data entry terminal or other conventional data input station, the data characterizing the state of congestion of the ski lift, after which, the data is communicated to the transmission source 180.

In the exemplary embodiment shown in FIG. 1, the transmission source 180 is configured to transmit the resort-specific information wirelessly, the information then being received by at least one exemplary apparatus according to the present invention via the receiver circuitry 110.

However, it should be noted that the resort-specific information may be transmitted to the apparatus using other methods. For example, in addition to or in lieu of the centralized transmission source 180, the resort-specific information may be made available at various information sources, e.g., data terminals or stations, throughout the resort. In this manner, a user could interface an exemplary apparatus to any of the stations, wherein the resort-specific information may be received by the receiver circuitry 110 using, for example, a cable connected to the station, a cradle connected to the station, an inferred link, a radio link, or by any other conventional communications link known in the related art.

With respect to the exemplary embodiment shown in FIG. 1, the resort-specific information is transmitted wirelessly via a radio link 190. For this purpose, the resort-specific information may be digitally encoded into binary data bits and then modulated to a carrier frequency, or, alternatively, may be encoded in an analog manner and then subsequently modulated to a carrier frequency. To encode the resort-specific information, any conventional encoding scheme may be used, such as, for example, Quadrature Phase Shift Keying (QPSK), in which each group of two binary data bits is transmitted as one of four different phases of a sinusoidal wave.

It should be noted that, although the exemplary embodiment shown in FIG. 1 refers to a wireless radio link, the present invention is intended to extend to and cover any and all conventional methods suitable for transmitting the resort-specific information wirelessly, such as, for example, over an inferred link, radio link, or otherwise.

Thus, at least at some times, the transmission source 180 would possess the resort-specific information, and this information may be subject to change periodically. For example, the congestion at a ski lift may change at least one time throughout the day.

If the transmission source 180 transmits the resort-specific information wirelessly, then it may do so automatically (i.e., without any manual direction from an operator) and periodically, such as, for example, every 20 seconds or every 20 minutes. However, it should be noted that periodic transmission does not require that the period of time between successive transmissions always be the same. For example, the transmission source 180 may transmit the resort-specific information wirelessly when at least a portion of the resort-specific information changes or when at least one non-time related condition occurs.

Further, if the transmission source 180 transmits the resort-specific information periodically, the period of time between successive transmissions should not exceed the amount of time an average patron is expected to remain at the resort. For example, in the skiing application, the average skier may ski from 8:00 A.M. to 4:00 P.M. (i.e., eight hours) and therefore the transmission source 180 should transmit the resort-specific information at least once every eight hours—this would ensure that the skier obtains the resort-specific information at least once while visiting the resort. Preferably, however, the period of time between successive transmissions should be as small as possible, to ensure that the user obtains up-to-date information.

The receiver circuitry 110 is situated in the housing 100 and configured to receive the resort-specific information. Receiver circuitry 110 includes circuitry suitable to receive the resort-specific information via any conventional communication method known in the related art, such as, for example, a cable, a cradle, a wireless link, or any combination of these methods.

In the embodiment shown in FIG. 1, receiver circuitry 110 includes circuitry capable of automatically receiving periodically transmitted resort-specific information wirelessly over radio link 190, e.g., receiver circuitry 110 is configured to receive the periodically transmitted resort-specific information automatically and without any intervention by the user. For this purpose, antenna 111 is electrically connected to radio processing circuitry 112.

Radio processing circuitry 112 may include any conventional radio receiver circuitry known in the art, such as, for example, circuitry capable of receiving Quadrature Amplitude Modulated signals (QAM), Pulse Width Modulated signals (PWM), or Quadrature Phase Shift Keyed signals (QPSK).

Once received, receiver circuitry 110 may store the resort-specific information in the memory unit 120. Or, alternatively, receiver circuitry 110 may communicate the information directly to the processing arrangement 130. For this purpose, receiver circuitry 110 may be connected to a data bus 140, to which the memory unit 120 and the processing arrangement 130 may also be connected, the communications unit 150 and the microprocessor 160 each also being connected (not shown) to the data bus 140. Or, alternatively, receiver circuitry 110 may communicate the information to the memory unit 120 and/or the processing arrangement 130 by using dedicated “hardwired” data lines (not shown).

The memory unit 120 may include any conventional writeable data storage device known in the related art, such as, for example, a Random Access Memory (RAM), EEPROM, EPROM, disk drive, hard disk, writeable CD-ROM drive, Mini-Disk, or the like.

Memory unit 120 may store at least the resort-specific information received from the receiver circuitry 110 and/or processed information received from the processing arrangement 130. Further, the memory unit 120 may store software necessary for the processing arrangement 130 to process the resort-specific information and communicate it to the user.

The processing arrangement 130 is configured to process the resort-specific information and format the information so that it may be communicated to the user. For this purpose, the processing arrangement 130 may include the microprocessor 160 with internal memory (not shown) and/or the external processor memory 170. The software required to process the resort-specific information may be stored in the memory unit 120, the internal processor memory, and/or the external processor memory 170.

It should be noted that, although FIG. 1 shows memory unit 120 and external processor memory 170 as two separate memory units, both memories may be combined into a single memory unit.

Moreover, it should be noted that the processing arrangement 130 may include other circuitry in addition to or in lieu of microprocessor 160 with external memory 170. For example, the processing arrangement 130 may include an array of integrated logic circuits, such as, for example, discrete logic circuits, an Application Specific Integrated Circuit (ASIC) and/or a programmable logic device, such as, for example, a Field Programmable Gate Array (FPGA) or a Programmable Logic Array (PAL). In this regard, the software required to process the resort-specific information may be stored on an external memory (not shown) accessible by the integrated logic circuits, or, alternatively, instructions necessary to process the resort-specific information may be “hardwired” directly into the integrated logic circuits (e.g., the processing of the resort-specific information may be effected solely by the integrated logic circuits, without need for specialized software).

The external processor memory 170 and/or the memory unit 120 may store, in addition to the software required to process the resort-specific information, intermediate processed data, e.g., the resort-specific information after processing, required to communicate the resort-specific information to the user.

The software required to process the resort-specific information at least formats the resort-specific information so that the communications unit 150 can properly communicate the information to the user.

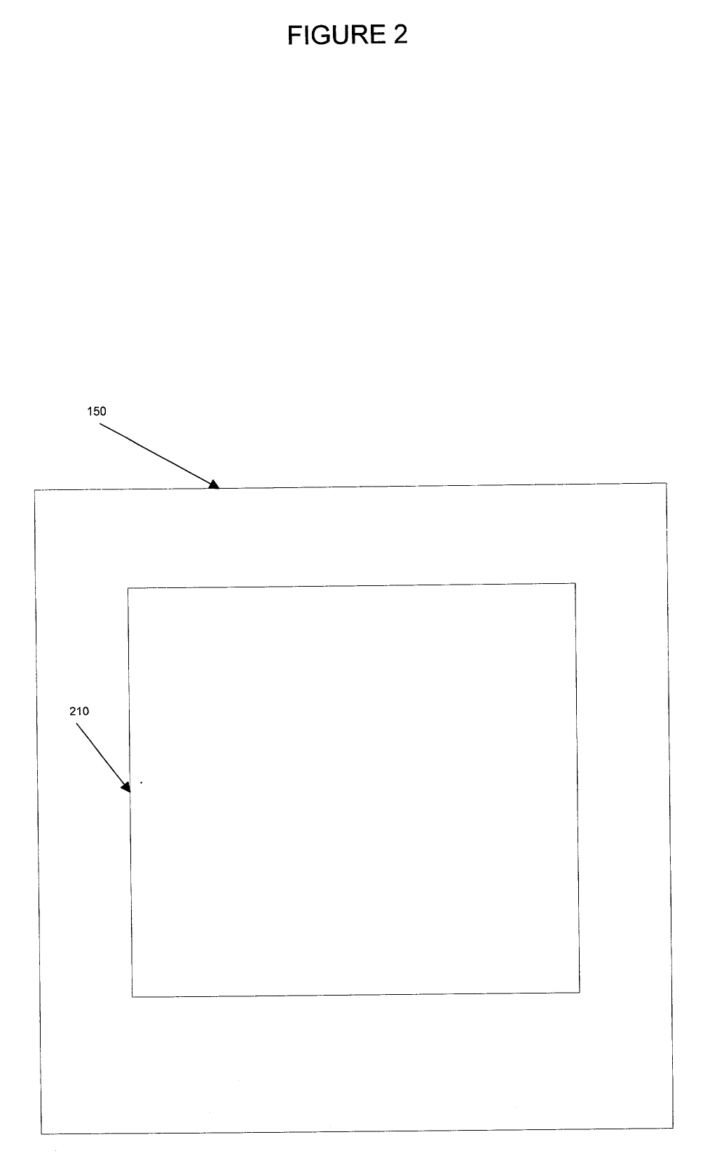

FIG. 2 shows an exemplary communications unit 150, including a visual interface arrangement 210 configured to visually display the processed resort-specific information to the user. Visual interface arrangement 210 may include, for example, a Light-Emitting Diode (LED) display device, a liquid-crystal display (LCD) device, a display device with touch screen capability for receiving user inputted information and/or any other conventional visual display device known in the related art.

It should be noted that, although FIG. 2 shows communications unit 150 including only a visual interface arrangement 210, communications unit 150 may include other arrangements in addition to or in lieu of the visual interface arrangement 210 for communicating the resort-specific information to the user, such as, for example, an audible interface arrangement (e.g., a speaker and voice-synthesizer arrangement) (not shown).

Communication unit 150, via visual interface arrangement 210, may communicate the resort-specific information in a variety of ways, depending upon how the processing arrangement 130 processes the information. For example, the processing arrangement 130 may process the resort-specific information so that the visual interface arrangement 210 displays the resort-specific information to the user in a text format. For example, in an exemplary embodiment of the present invention for use at a ski resort, the visual interface arrangement 210 may display text information relating to at least one of a plurality of ski trails (e.g., which of a plurality of ski trails are open or closed), information relating to at least one of a plurality of ski lifts (e.g., which of a plurality of ski lifts are operational or non-operational), information relating to a snow condition of at least one of the plurality of ski trails (e.g., icy, packed-powder, powder, and/or slushy), and/or information relating to a skier congestion of at least one of the plurality of ski lifts (e.g., information characterizing the number of people currently on line at a ski lift).

In addition to or in lieu of the text display of the resort-specific information, the visual interface arrangement 210 may communicate the resort-specific information to the user in graphical form. For example, in the ski resort application discussed above, the trails which are open or closed may be visually indicated on a digital map of the ski resort, such as, for example, by changing the color of closed trails on the digital map, hatching out closed trails, “flashing” closed trails, displaying text such as “closed” across closed trails, or the like. The digital map of the resort, which may include binary data suitable for being displayed as a graphical map, may be received by the receiver circuitry 110, for example, wirelessly, or, alternatively, may be downloaded over a cable from an information source, such as, for example, a computer server, a web-site, one of a plurality of permanent data terminals or stations throughout the resort, and/or a personal computer. The circuitry required to download the map may include any conventional receiver circuitry, and may be part of receiver circuitry 110 or reside separately within housing 100.

Other resort-specific information may be displayed by the visual interface arrangement 210. For example, in the ski resort application, the congestion of at least one of a plurality of ski lifts may be displayed on the digital map of the resort, such as, for example, as a number characterizing the severity of the congestion, a color bar or other indication in the locality of at least one of the plurality of ski lifts on the digital map, by changing the color of the ski lift on the map, each color representing a unique congestion (e.g., green, yellow, and red), and/or text overlaying the map, textually indicating the congestion.

It should be noted that the visual interface arrangement 210 is capable of displaying any information, including a portion of or all of the resort-specific information, graphically, textually, or a combination of both graphically and textually.

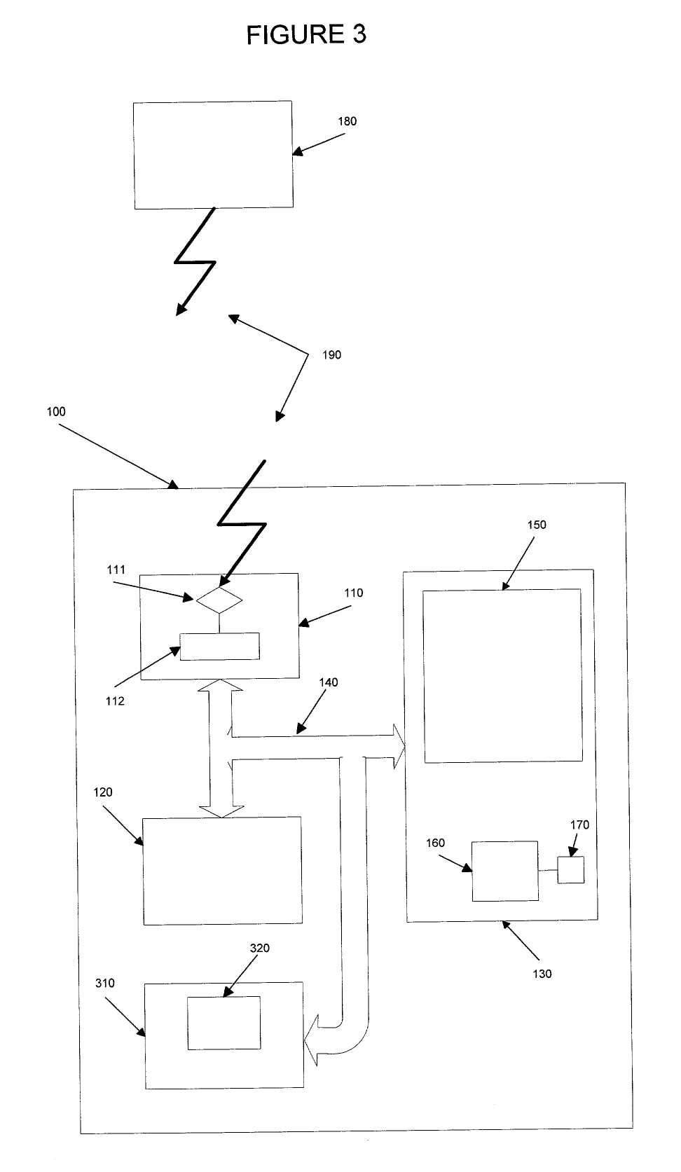

FIG. 3 shows another exemplary apparatus according to the present invention for communicating information to a user, the apparatus including all the components of the exemplary embodiment shown in FIG. 1 as well as location determination circuitry 310, which may include, for example, GPS locator circuitry 320 capable of determining a geographical position of the apparatus by processing signals received from GPS satellites in a conventional manner known in the art. In the exemplary embodiment shown in FIG. 3, the location determination circuitry 310 is connected to data bus 140 and is configured to provide the processing arrangement 130 with the geographical position of the apparatus.

It should be noted that the location determination circuitry 310 need not be connected to a bus and need not provide the processing circuitry with the geographical position of the apparatus directly. Alternatively, the location determination circuitry 310 may be connected to the processing arrangement 130 directly using “hardwired” data lines (not shown). Or, the location determination circuitry 310 may store the geographical position of the apparatus in memory unit 120 or an additional external memory (not shown), via the data bus 140 or dedicated “hardwired” data lines (not shown), from which the processing arrangement 130 may retrieve the geographical position for further processing as described below.

The exemplary embodiment of FIG. 3 is believed to be advantageous in that, in addition to communicating the resort-specific information to the user, the geographical position of the apparatus (i.e., the geographical position of the user), may be communicated as well. As with communicating the resort-specific information, the geographical position may be communicated, for example, using the visual interface arrangement 210 or, alternatively, an audible interface arrangement (not shown). With respect to the visual interface arrangement 210, the geographical position may be communicated as text and/or by graphical representation, such as, for example, by a graphical indicator (e.g., an arrow, dot, or otherwise) on the digital map of the resort. In this manner, the user would be able to determine, at a glance, his/her location within the resort, in addition to being provided with the resort-specific information.

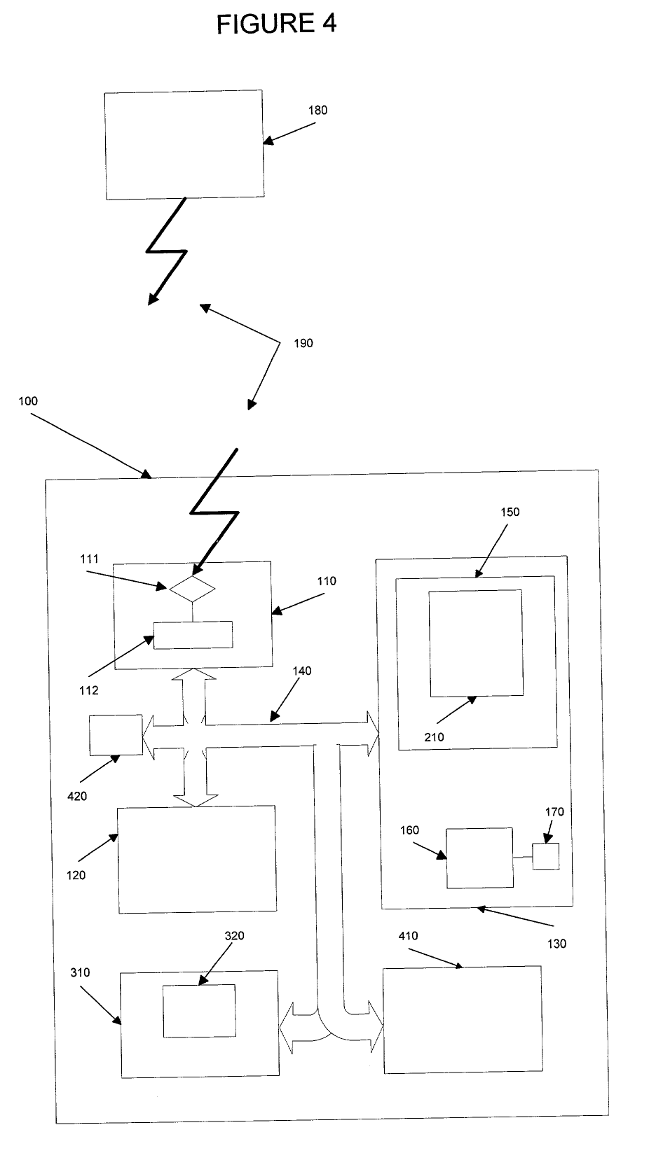

FIG. 4 shows yet another exemplary apparatus according to the present invention for communicating information to a user, the apparatus including all the components of the exemplary embodiment shown in FIG. 3 as well as a user input arrangement 410 configured to receive user inputted information from the user. User input arrangement 410 may include any conventional circuitry known in the related art for receiving data input from the user, such as, for example, a keypad, a microphone with voice recognition circuitry, a touch screen (e.g., the visual interface arrangement 210 may include touch screen capabilities), joystick, and/or a mouse.

In the exemplary embodiment shown in FIG. 4, the user input arrangement 410 is connected to data bus 140 for communicating the user inputted information to at least one of the memory unit 120 and the processing arrangement 130. However, it should be noted that the user input arrangement 410 need not be connected to the data bus 140, but rather be connected to at least one of the memory unit 120 and the processing arrangement 130 by “hardwired” data lines (not shown).

User input arrangement 410 receives data from the user that may change the way the resort-specific information, the digital map of the resort, and/or the geographical position of the apparatus are displayed to the user. For example, in the ski resort application, a skier may input his/her skiing skill level, which may include a characterization of which of the plurality of ski trails are within the skier's ability and/or which are not. Further, a skill level may be assigned to each of the plurality of ski trails, indicating the relative difficulty of skiing that particular trail, for example, ski resorts often indicate the difficulty of a particular trail on the paper foldable maps with a green circle for beginner, a blue square for intermediate, a black diamond for advanced, or a double black diamond for expert. The skill level assigned to each of the plurality of ski trails may be encoded along with encoded digital map and stored in memory unit 120, stored on an additional memory device (not shown), or provided directly to the processing arrangement 130. In this manner, the processing arrangement 130 acquires both the skill level of the skier and the skill level assigned to each of the plurality of ski trails. With this information, the processing arrangement 130 may cause visual interface arrangement 210 to display the digital map differently, for example, by changing the color of trails on the digital map having assigned skill levels that exceed the skill level of the user, or by using some other visual or textual indication of which trails have assigned skill levels that exceed the skill level of the user. In this manner, the user could determine, at a glance, the trails within the resort that are within the skier's abilities.

The exemplary apparatus shown in FIG. 4 may also include an alarm arrangement 420 configured to alarm the user if the geographical position of the apparatus coincides with a geographical position of at least one location within the resort. In this manner, the alarm arrangement 420 may alert a skier, for example, if he/she traverses over at least a portion of one of the trails having an assigned skill level that exceeds the skill level of the user (e.g., if the skier wanders onto a trail exceeding his or her skiing ability). Or, the alarm arrangement 420 may alert the user if he/she traverses over a forbidden area of the resort, such as, for example, a portion of the resort in which only employees have access or a portion of the resort that may be dangerous to the user, such as, for example, wooded areas between ski trails.

In the exemplary embodiment shown in FIG. 4, the alarm arrangement 420 is connected to data bus 140 for receiving geographical position information from the processing arrangement 130. However, it should be noted that alarm arrangement 420 need not be connected to the data bus 140, but rather may be connected, for example, to the processing arrangement 130 by “hardwired” data lines (not shown).

The information concerning at least the forbidden areas and/or the portions of the resort that may be dangerous may be received by the receiver circuitry 110, for example, wirelessly, or, alternatively, may be downloaded over a cable from an information source, such as, for example, a computer server, a web-site, one of a plurality of permanent data terminals or stations throughout the resort, and/or a personal computer. The circuitry required to download the information concerning forbidden areas and/or portions of the resort that may be dangerous may include any conventional receiver circuitry, and may be part of receiver circuitry 110 or reside separately within housing 100. In one exemplary apparatus according to the present invention, the information on forbidden areas and/or portions of the resort that may be dangerous may be encoded along with the encoded digital map (e.g., the information on forbidden areas and/or portions of the resort that may be dangerous would be included with and accompany the downloaded data representing the digital map of the resort).

User input arrangement 410 may also receive, as an input from the user, at least one destination point located within the resort, wherein the processing arrangement 130 is further configured to communicate a path of travel to the user, a beginning of the path of travel coinciding with the geographic position of the apparatus and an end of the path of travel coinciding with the at least one destination point. In this manner, the user may plot a course through the resort to a desired location. For example, a skier may wish to travel from his current location to one of several ski lodges located within the resort. The processing arrangement 130 could, for example, display the path of travel on the digital map via the visual interface arrangement 210.

In doing so, the processing arrangement 130 may consider the skier's skill level and at least some portions of the resort-specific information, such as, for example, which of the plurality of ski lifts are closed or operational, which of the plurality of ski trails are open, and/or the skier congestion of the at least one ski lift. In this manner, the processing circuitry may plot the course of travel so that it traverses only trails that are both open and do not have an assigned skill level that exceeds the skill level of the user.

The processing circuitry may also plot the course of travel so that it does not traverse forbidden areas of the resort, such as, for example, a portion of the resort in which only employees have access or a portion of the resort that may be dangerous to the user, such as, for example, wooded areas between ski trails.

In the ski application, the processing circuitry may also plot the course of travel so that it traverses over a course of at least one of the ski lifts (e.g., the course of travel may require the skier to use one of the ski lifts in order to travel to the desired destination point). In doing so, the processing arrangement 130 may plot the course of travel so that it does not include the course of ski lifts which may be closed or which may have a skier congestion that is too high. For example, a skier may input data into the user input arrangement 410 indicating a desire not to use lifts that have a wait time of more than, for example, 15 minutes, that is, a ski lift having a skier congestion which would result in the skier having to wait more than 15 minutes to use the ski lift. With this information, the processing arrangement 130 may exclude the course of ski lifts having or exceeding the indicated congestion when plotting the course of travel.

The processing arrangement 130 may also plot the course of travel so that it traverses over locations near concession stands, restaurants, or other locations which may generate revenue for the resort.

It should be noted that, although the exemplary embodiment shown in FIG. 4 is configured to display the course of travel to the user via the visual interface arrangement 210, the path of travel may be communicated to the user by any conventional method of communicating data, such as, for example, by use of an audible interface (not shown), in which the path of travel is communicated to the user via synthesized speech, recorded voice, or otherwise.

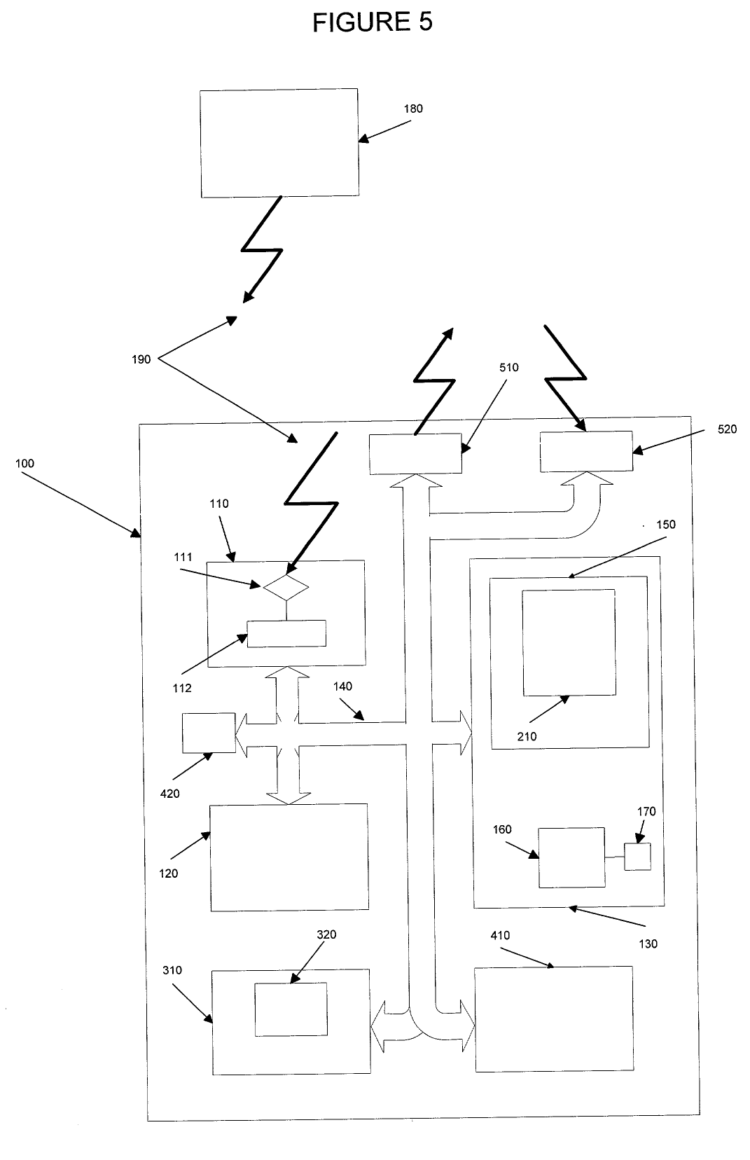

FIG. 5 shows yet another exemplary apparatus according to the present invention for communicating information to a user, the apparatus including all the components of the exemplary embodiment shown in FIG. 4 as well as a transmitting arrangement 510 configured to wirelessly transmit at least the geographical position of the apparatus. The transmitting arrangement 510 may include any conventional wireless transmitting arrangement known in the related art. For example, the geographical position of the apparatus may be digitally encoded into binary data bits and modulated to a carrier frequency, or, alternatively, may be encoded in an analog manner and then subsequently modulated to a carrier frequency. To encode the geographical position of the apparatus, any conventional encoding scheme may be used, such as, for example, Quadrature Phase Shift Keying (QPSK), in which each group of two binary data bits is transmitted as one of four different phases of a sinusoidal wave.

The exemplary apparatus shown in FIG. 5 may also include position receiving arrangement 520, which is configured to receive a geographical position transmitted by at least one other apparatus according to the present invention. The position receiving arrangement 520 is connected to the processing arrangement 130, for example, by data bus 140 or by dedicated “hardwired” lines (not shown). In this manner, different users using different ones of the exemplary apparatus shown in FIG. 5 could determine the location of one another, even when the different users are separated within the resort.

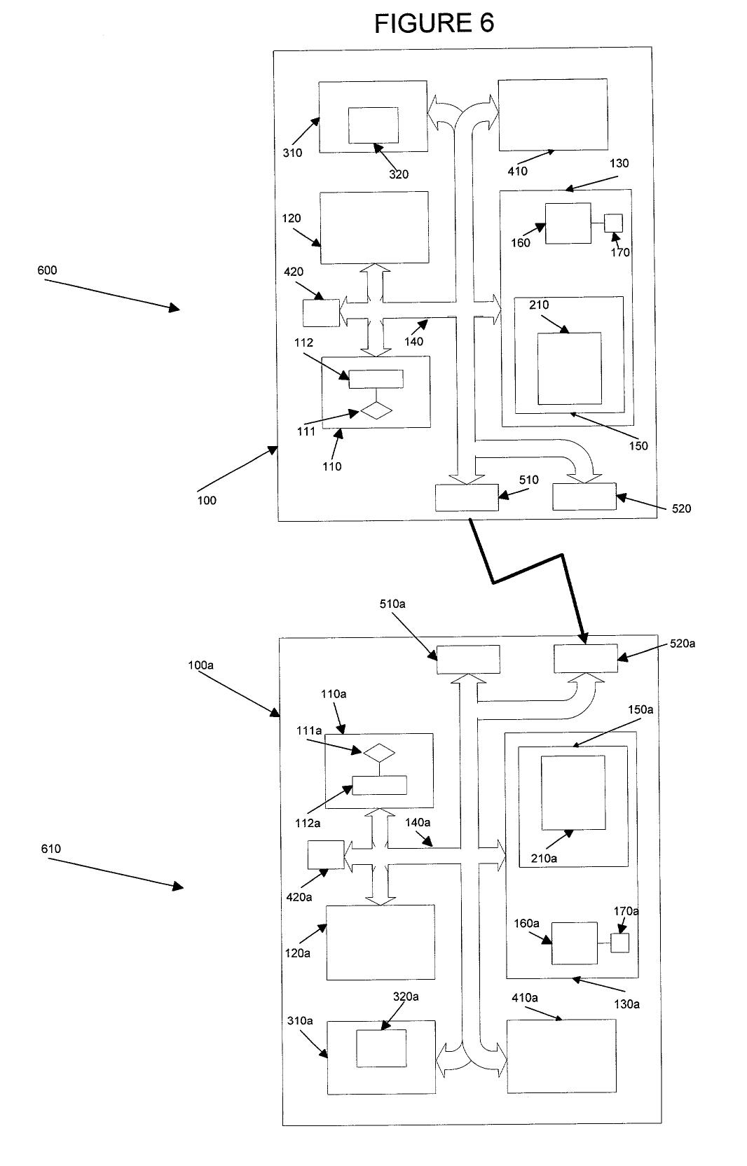

FIG. 6 shows a first exemplary apparatus 600 according to the present invention communicating its geographical position to a second exemplary apparatus 610 according to the present invention, the second exemplary apparatus 610 including a housing 100a, a power source (not shown), receiver circuitry 110a (having antenna 111a and radio processing circuitry 112a), processing arrangement 130a (having microprocessor 160a, processor memory 170a, communications unit 150a (having visual interface arrangement 210a), memory unit 120a, alarm unit 420a, data bus 140a, location determination circuitry 310a (having GPS locator circuitry 320a), user input arrangement 410a, transmitting arrangement 510a, and position receiving arrangement 520a. The transmitting arrangement 510 of the first exemplary apparatus 600 may receive its geographical position from its memory unit 120, its location determination circuitry 310, or its processing arrangement 130. Afterwards, the transmitting arrangement 510 may transmit the geographical position of the first exemplary apparatus 600 wirelessly into the surrounding environment, where it is subsequently received by position receiving arrangement 520a of at least the second exemplary apparatus 610. Position receiving arrangement 520a then communicates the geographical position of the first exemplary apparatus 600 to the processing arrangement 130a of the second apparatus 610, such as, for example, by data bus 140a or by dedicated “hardwired” lines (not shown). Then, the processing arrangement 130a of the second exemplary apparatus 610 may communicate the geographical position of the first exemplary apparatus 600 to the user of the second exemplary apparatus 610, such as, for example, by causing visual interface arrangement 210a to display a graphical indicator (e.g., arrow, dot, marker, etc.) on the digital map of the resort indicating the location of the user of the first exemplary apparatus 600.

The processing arrangement 130 of the first exemplary apparatus 600 may also tag the geographical position data with a “group tag” before the transmitting arrangement 510 transmits the geographical position data. The processing arrangement 130 could, for example, add a series of bits to the encoded geographical position of the first exemplary apparatus 600, corresponding to a unique group tag/identifier inputted by the user into user input arrangement 410. This would permit users of a group, such as, for example, a family or a group of friends, to receive only geographical position data from other users in the group, so that the visual interface arrangement 210, 210a would not display the geographical position of persons not in the group.

For this purpose, after the position receiving arrangement 520a of the second exemplary apparatus 610 receives a geographical position transmitted by the first exemplary apparatus 600 together with the group tag information (i.e. group tag data bits) of the first exemplary apparatus 600, the processing arrangement 130a compares the group tag transmitted by the first exemplary apparatus 600 with a group tag assigned to the second exemplary apparatus 610, e.g., a group tag/identifier inputted by the user of the second exemplary apparatus 610 into user input arrangement 410a. If the group tags match, then the processing arrangement 130a communicates the geographical position of the first exemplary apparatus 600 to the user of the second exemplary apparatus 610, such as, for example, by causing visual interface arrangement 210a to display a graphical indicator (e.g., arrow, dot, marker, etc.) on the digital map of the resort indicating the location of the user of the first exemplary apparatus 600. If the group tags do not match, then the processing arrangement 130a will not cause the visual interface arrangement 210a to display the graphical indicator.

It should be noted that the “group tag” may assume other forms besides additional bits added before and/or after the encoded geographical position data. The present invention is intended to include any and all conventional methods of adding unique identifier information to a transmitted data stream, such as, for example, adding data bits at the beginning of the encoded geographical position data, adding data bits at the end of the encoded geographical position data, adding data bits in the middle of the encoded geographical position data, and/or any other conventional form of adding unique identifier information to a data bit stream.

It should also be noted that the exemplary embodiment described above is not limited to receiving geographical position information from only one other exemplary apparatus. The processing arrangement 130, 130a may receive transmissions of a plurality of geographical positions from a plurality of exemplary apparatuses. In this manner, the processing arrangement 130, 130a may display the geographical position of a plurality of members of a group transmitting the same group tag information. To receive multiple transmissions from multiple transmission sources, the transmitting arrangement 510, 510a and position receiving arrangement 520, 520a may include conventional circuitry capable of multiple access transmission and receiving, such as, for example, conventional Frequency Division Multiple Access (FDMA), conventional Code Division Multiple Access (CDMA), and/or conventional Time Division Multiple Access (TDMA).

It should be noted that the various embodiments described above show receiver circuitry 110, 110a and position receiving arrangement 520, 520a as two separate units. However, the circuitry of both the receiver circuitry 110, 110a and the position receiving arrangement 520, 520a may be combined into a single unit (not shown) and may, for example, use a single antenna to receive all transmissions, and the single antenna may also be used by the transmitting arrangement 510, 510a to transmit the geographical position data.

Furthermore, the circuitry of the transmitting arrangement 510, 510a may be combined with the circuitry of both the receiver circuitry 110, 110a and the position receiving arrangement 520, 520a to form a single transponder (not shown).

What is claimed is:

1. An apparatus for providing information to a user at a resort, comprising:
a housing configured for being at least one of held and worn by the user;
a power source for providing power to the apparatus;
receiver circuitry situated in the housing, the receiver circuitry including at least one of a first circuit arrangement configured to receive resort-specific information non-wirelessly and a second circuit arrangement configured to receive the resort-specific information wirelessly, the first circuit arrangement being further configured to receive the resort-specific information from at least one information source located within the resort, the second circuit arrangement being further configured to receive the resort-specific information automatically and periodically;
a memory unit situated in the housing and configured to store the resort-specific information; and
a processing arrangement, the processing arrangement including a communication unit configured to communicate at least a portion of the resort-specific information to the user.

2. The apparatus according to claim 1, wherein the communication unit of the processing arrangement includes at least one of a visual interface arrangement and an audible interface arrangement, the visual interface arrangement being configured to visually communicate at least the portion of the resort-specific information to the user and the audible interface arrangement being configured to audibly communicate at least the portion of the resort-specific information to the user.

3. The apparatus according to claim 2, wherein the visual interface arrangement is further configured to visually display at least a digital map of the resort.

4. An apparatus for providing information to a user at a ski resort, comprising:
a housing configured for being at least one of held and worn by the user;
a power source for providing power to the apparatus;
receiver circuitry situated in the housing, the receiver circuitry including at least one of a first circuit arrangement configured to receive resort-specific information non-wirelessly and a second circuit arrangement configured to receive the resort-specific information wirelessly, the first circuit arrangement being further configured to receive the resort-specific information from at least one information source located within the resort, the second circuit arrangement being further configured to receive the resort-specific information automatically and periodically, the resort-specific information including at least one of information relating to at least one of a plurality of ski trails, information relating to at least one of a plurality of ski lifts, information relating to a snow condition of at least one of the plurality of ski trails, and information relating to a skier congestion of at least one of the plurality of ski lifts;
a memory unit situated in the housing and configured to store the resort-specific information; and
a processing arrangement, the processing arrangement including a communication unit configured to communicate at least a portion of the resort-specific information to the user.

5. The apparatus according to claim 4, wherein the communication unit of the processing arrangement includes at least one of a visual interface arrangement and an audible interface arrangement, the visual interface arrangement being configured to visually communicate at least the portion of the resort-specific information to the user and the audible interface arrangement being configured to audibly communicate at least the portion of the resort-specific information to the user.

6. The apparatus according to claim 5, wherein the visual interface arrangement is further configured to visually display at least a digital map of the ski resort.

7. An apparatus for providing information to a user at a resort, comprising:
a housing configured for being at least one of held and worn by the user;
a power source for providing power to the apparatus;
receiver circuitry situated in the housing, the receiver circuitry including at least one of a first circuit arrangement configured to receive resort-specific information non-wirelessly and a second circuit arrangement configured to receive the resort-specific information wirelessly, the first circuit arrangement being further configured to receive the resort-specific information from at least one information source located within the resort, the second circuit arrangement being further configured to receive the resort-specific information automatically and periodically;
a memory unit situated in the housing and configured to store the resort-specific information;
location determination circuitry including GPS circuitry configured to receive signals from GPS satellites, wherein the GPS circuitry determines a geographical position of the apparatus as a function of the signals; and
a processing arrangement, the processing arrangement including a communication unit configured to communicate at least a portion of the resort-specific information to the user.

8. The apparatus according to claim 7, wherein the communication unit of the processing arrangement includes a visual interface arrangement configured to visually display to the user at least one of a digital map of the resort, the geographical position of the apparatus, and the portion of the resort-specific information.

9. The apparatus according to claim 7, wherein the portion of the resort-specific information includes at least one of information relating to at least one of a plurality of ski trails, information relating to at least one of a plurality of ski lifts, information relating to a snow condition of at least one of the plurality of ski trails, and information relating to a skier congestion of at least one of the plurality of ski lifts.

10. The apparatus according to claim 7, further comprising:
an alarm arrangement configured to alarm the user if the geographical position of the apparatus coincides with a geographical position of at least one location within the resort.

11. The apparatus according to claim 10, further comprising:
a user input arrangement configured to receive user inputted information from the user, the user inputted information including at least a skill level of the user, wherein the alarm arrangement alarms the user if the geographical position of the apparatus coincides with a geographical position of at least a portion of one of a plurality of ski trails having an assigned skill level that exceeds the skill level of the user.

12. The apparatus according to claim 7, further comprising:
a user input arrangement configured to receive user inputted information from the user, the user inputted information including at least one destination point located within the resort, wherein the processing arrangement is further configured to communicate a path of travel to the user, a beginning of the path of travel coinciding with the geographic position of the apparatus and an end of the path of travel coinciding with the at least one destination point, the communication unit of the processing arrangement communicating the path of travel to the user at least one of audibly and visually.

13. The apparatus according to claim 12, wherein the user inputted information includes a skill level of the user, the path of travel being determined at least in accordance with the skill level of the user.

14. The apparatus according to claim 12, wherein the path of travel is determined at least in accordance with the resort-specific information.

15. The apparatus according to claim 14, wherein the path of travel is determined in accordance with at least one of information relating to at least one of a plurality of ski trails, information relating to at least one of a plurality of ski lifts, information relating to a snow condition of at least one of the plurality of ski trails, and information relating to a skier congestion of at least one of the plurality of ski lifts.

16. The apparatus according to claim 15, wherein the path of travel traverses at least one of a portion of at least one of the plurality of ski trails and a course of at least one of the plurality of ski lifts.

17. The apparatus according to claim 15, further comprising:
an alarm arrangement, the user inputted information including a skill level of the user, the alarm arrangement being configured to alarm the user if the geographical position of the apparatus coincides with a geographical position of at least a portion of one of the plurality of ski trails and a skill level assigned to the one of the plurality of ski trails exceeds the skill level of the user.

18. The apparatus according to claim 12, wherein the communication unit of the processing arrangement includes a visual interface arrangement configured to visually display at least one of a digital map of the resort, the geographical position of the apparatus, and the portion of the resort-specific information.

19. The apparatus according to claim 18, wherein the portion of the resort-specific information includes at least one of information relating to at least one of a plurality of ski trails, information relating to at least one of a plurality of ski lifts, information relating to a snow condition of at least one of the plurality of ski trails, and information relating to a skier congestion of at least one of the plurality of ski lifts.

20. An apparatus for providing information to a user at a resort, comprising:
a housing configured for being at least one of held and worn by the user;
a power source for providing power to the apparatus;
receiver circuitry situated in the housing, the receiver circuitry including at least one of a first circuit arrangement configured to receive resort-specific information non-wirelessly and a second circuit arrangement configured to receive the resort-specific information wirelessly, the first circuit arrangement being further configured to receive the resort-specific information from at least one information source located within the resort, the second circuit arrangement being further configured to receive the resort-specific information automatically and periodically;
a memory unit situated in the housing and configured to store the resort-specific information;
location determination circuitry including GPS circuitry configured to receive signals from GPS satellites, wherein the GPS circuitry determines a geographical position of the apparatus as a function of the signals;
a processing arrangement, the processing arrangement including a communication unit configured to communicate at least a portion of the resort-specific information to the user; and
a transmitting arrangement configured to wirelessly transmit at least the geographical position of the apparatus.

21. The apparatus according to claim 20, further comprising:
a position receiving arrangement configured to wirelessly receive at least one transmitted geographical position, the communication unit of the processing arrangement communicating the at least one transmitted geographical position to the user.

22. The apparatus according to claim 21, wherein the communication unit of the processing arrangement communicates the at least one transmitted geographical position to the user only if a transmitted group tag assigned to the at least one transmitted geographical position matches a group tag assigned to the apparatus.

23. The apparatus according to claim 22, further comprising:
a user input arrangement configured to receive user inputted information from the user, the user inputted information including at least group identifier information, wherein the group tag is assigned to the apparatus in accordance with the group identifier information, the communication unit of the processing arrangement communicating the at least one transmitted geographical position to the user at least one of visually and audibly.
